(19) United States
(12) Patent Application Publication
(10) Pub. No.: US 2007/0171676 A1
(43) Pub. Date: Jul. 26, 2007

(54) Backlight module

(75) Inventor: Shao-Han Chang, Tu-cheng (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: HON HAI Precision Industry CO., LTD., Tu-Cheng City (TW)

(21) Appl. No.: 11/508,542

(22) Filed: Aug. 23, 2006

(30) Foreign Application Priority Data
Jan. 20, 2006 (TW) 95102362

(51) Int. Cl. F21V 7/04

(52) U.S. Cl. 362/613

(57) ABSTRACT

A backlight module includes a housing, at least two light sources, and a light diffusion plate. The housing includes a base, a plurality of sidewalls extending from the peripheral of the base to define an opening, and a protrusion extending out from the base toward the opening. The protrusion defines two opposing reflective surfaces facing two opposing sidewalls respectively. The light diffusion plate is disposed on the opening of the housing. The two light sources are fixed on inner surface of the two opposing sidewalls respectively, the two reflecting surfaces uniformly reflecting light from the light sources toward the light diffusion plate. The present backlight module has a good optical performance, lightweight and thin body.

### CROSS-REFERENCE TO RELATED APPLICATIONS

This application is related to co-pending U.S. Patent Applications, entitled “LIGHT SOURCE MODULE AND BACKLIGHT SYSTEM USING THE SAME”, by Shao-Han Chang and Fen Chen with Attorney Docket No. 14963-56245; entitled “DIRECT TYPE BACKLIGHT MODULE”, by Shao-Han Chang with Attorney Docket No. 14963-56244; entitled “BACKLIGHT SYSTEM”, by Shao-Han Chang Attorney Docket No. 14963-56248. Such applications have the same assignee as the present application and have been concurrently filed herewith. The disclosure of the above identified applications is incorporated herein by reference.

### TECHNICAL FIELD

The present invention relates to backlight modules, more particularly, to a hollow reflective backlight module for use in, for example, a liquid crystal display (LCD).

### BACKGROUND

Most LCD devices are passive devices in which images are displayed by controlling an amount of light input from an outside light source. Thus, a separate light source (for example, backlight module) is generally employed for illuminating an LCD.

Generally, backlight modules can be classified into an edge lighting type or a bottom lighting type based upon the location of lamps within the devices. The edge lighting type backlight module has a lamp unit arranged at a side portion of a light guiding plate for guiding light. The edge lighting type backlight modules are commonly employed in small-sized LCD due to their lightweight, small size, and low electricity consumption. However, the edge lighting type backlight module has a relative lower optical brightness. A bottom lighting type backlight module has a plurality of lamps arranged in regular positions to directly illuminate an entire surface of an LCD panel. The bottom lighting type backlight modules have higher efficiency of light usage than the edge lighting type backlight modules. However, the bottom lighting type backlight module has a relative lower luminance uniformity.

In order to overcome the above mentioned shortcomings, a hollow type backlight module is provided. Referring to FIG. 7, a typical hollow backlight module 10 includes a first light guide plate 11, a second light guide plate 12, two light sources 13, a reflecting plate 14, and a diffusing film 15. The first light guide plate 11 includes a first inner surface 111 and a first outer surface 112. The second light guide plate 12 includes a second inner surface 121 and a second outer surface 122. The first and second inner surfaces 111 and 121 are inner concave curvature surfaces. The second light guide plate 12 and the first light guide plate 11 cooperatively forms a hollow light-guiding zone 16 therebetween.

The two light sources 13 are located at two sides of the hollow light-guiding zone 16. Each light source 13 includes a plurality of lamp tubes 131 and a reflector 132. Light from the two light sources 13 transmits into the hollow light-guiding zone 16, and then enters the first and the second light guide plates 11 and 12 through the first and the second inner surfaces 111 and 121. The reflecting plate 14 are located below the second outer surface 122 of the second light guide plate 12 to reflect the light emitting from the second light guide plate 12 to re-enter into the hollow light-guiding zone 16. The diffusing film 15 is located above the first outer surface 112 of the first light guide plate 11 for diffusing the light emitting from the first light guide plate 11 and producing uniform light output. Typically, the light sources positioned directly under optical sheets may occur potential dark strips caused by the reduced intensity of light between adjacent light sources. This configuration of the backlight module 10 avoids light sources 13 being positioned directly under the first light guide plate 11, so as to attain a relative good optical uniformity.

However, the backlight module 10 increase cost of materials due to an employment of two light guide plates 11 and 12, further increasing its weight. In addition, because the first and second light guide plate 11 and 12 are usually formed of transparent synthetic resin material, such as polymethyl methacrylate (PMMA) and polycarbonate (PC), the first and second light guide plates 11 and 12 have thermal deformation and deflection problems because they absorb a great deal of heat energy produced by the lamp tubes 131, furthermore, the first and the second light guide plates 11 and 12 may change color and have transformation problems due to long-term irradiation by the lamp tubes 131. This would shorten a service life of the backlight module of the LCD. Furthermore, the backlight module 10 has a significant large thickness due to a design of the hollow light-guiding zone 16 with the first and second light guide plate 11 and 12.

What is needed, therefore, is a backlight module that overcome the above mentioned shortcomings.

### SUMMARY

A backlight module according to a preferred embodiment includes a housing, at least two light sources, and a light diffusion plate. The housing includes a base, a plurality of sidewalls extending from the peripheral of the base to define an opening, and a protrusion extending out from the base toward the opening. The protrusion defines two opposing reflective surfaces facing two opposing sidewalls respectively. The light diffusion plate is disposed on the opening of the housing. The two light sources are fixed on inner surfaces of the two opposing sidewalls correspondingly, the two reflecting surfaces uniformly reflecting light from the light sources toward the light diffusion plate.

Other advantages and novel features will become more apparent from the following detailed description of the preferred embodiments, when taken in conjunction with the accompanying drawings.

### BRIEF DESCRIPTION OF THE DRAWINGS

Many aspects of the present backlight module can be better understood with reference to the following drawings. The components in the drawings are not necessarily drawn to scale, the emphasis instead being placed upon clearly illustrating the principles of the present backlight module. Moreover, in the drawings, like reference numerals designate corresponding parts throughout the several views.

FIG. 1 is a schematic, cross-sectional view of a backlight module according to a first preferred embodiment;

FIG. 2 is a schematic, cross-sectional view of the backlight module of FIG. 1 showing light paths;

FIG. 3 is a schematic, cross-sectional view of a backlight module according to a second preferred embodiment;

FIG. 4 is a schematic, cross-sectional view of a backlight module according to a third preferred embodiment;

FIG. 5 is a schematic, cross-sectional view of a backlight module according to a fourth preferred embodiment;

FIG. 6 is a schematic, cross-sectional view of a backlight module according to a fifth preferred embodiment; and

FIG. 7 is a schematic, cross-sectional view of a conventional backlight module.

### DETAILED DESCRIPTION OF THE PREFERRED EMBODIMENTS

Reference will now be made to the drawings to describe preferred embodiments of the present backlight module, in detail.

Referring to FIG. 1, a backlight module 20 in accordance with a first preferred embodiment is shown. The backlight module 20 includes a housing 21, a plurality of light sources 22, and a light diffusion plate 23. The housing 21 includes a base 211, four sidewalls 212 extending from the peripheral of the base 211 to define an opening 213, and a protrusion 214 extending out from the base 211 towards the opening 213. The protrusion 214 defines a first and second opposite reflective surfaces 2142 and 2144 facing the two opposing sidewalls 212 correspondingly. The light diffusion plate 23 is disposed on the opening 213 of the housing 21. The light sources 22 are fixed on an inner surface of the two opposing sidewalls 212 correspondingly. The first and second reflective surfaces 2142 and 2144 uniformly reflect an amount of light rays from the light sources 22 toward the light diffusion plate 23, thus surface light rays are outputted from the light diffusion plate 23.

In this embodiment, the protrusion 214 is disposed on the middle of the base 212. A shape of the protrusion 214 is an elongated ridge extending along a direction parallel to the two opposing sidewalls 212 where the light sources 22 are fixed. The protrusion 214 has a similar semi-circular cross-section taken along a direction perpendicular to the two opposing sidewalls 212 that fixes the light sources 22 thereon. The first and second reflective surfaces 2142 and 2144 of the protrusion 214 are curved surfaces connecting with the base 211. The first and second reflective surfaces 2142 and 2144 are used for uniformly reflecting the light rays to the light diffusion plate 23.

In order to improve the backlight module 20's light energy utilization rate, the housing 21 further includes two upper reflective units 216 each positioned on a top of the two opposing sidewalls 212 where the light sources 22 are fixed. In this embodiment, each upper reflective unit 216 includes a first protruding portion 2162 extending from a top the sidewalls 212 towards an inner area of an upper part of the housing 21, a second protruding portion 2164 extending from a bottom surface of the protruding portion 2162 towards the base 211, and a third reflective surface 2166 defined by the intersection between the first protruding portion 2162 and the second protruding portion 2164 facing the corresponding reflective surface 2142 or 2144. The third reflective surface 2166 is a curved surface. An amount of light rays from the light sources 22 may be reflected to the first and second reflective surfaces 2142 and 2144 and further reflected again by third reflective surface 2166.

In the same way, the housing 21 further includes two bottom reflective units 218 each positioned on the base 211 adjacent to the corresponding sidewall 212. In this embodiment, each bottom reflective unit 218 includes a third protruding portion 2182 extending from the base 211 toward the 2164 correspondingly, and a fourth reflective surface 2186 defined by an intersection between the base 211 and the third protruding portion 2182, facing the third curved reflective surface 2166 and interconnecting the adjacent reflective surface 2142 or 2144. The fourth reflective surface 2186 is a curved surface. An amount of light rays from the light sources 22 may be reflected to the light diffusion plate 23 by the fourth reflective surface 2186. The sidewall 212, the second protruding portion 2164, and the third protruding portion 2182 cooperatively define a chamber 210 to receive the light sources 22.

A plurality of light sources 22 may not only be regularly adhered to the inner surface of each sidewall 212 facing the first and second reflective surfaces 2142 and 2144 directly, but may also be fixed on two electric circuit boards 221. Each electric circuit board 221 with the light sources 22 is correspondingly inserted into a corresponding chamber 210, with the light sources 22 directly facing the first and second reflective surfaces 2142 and 2144. In this embodiment, the light sources 22 are LEDS, and the light sources 22 are fixed on the electric circuit board 221.

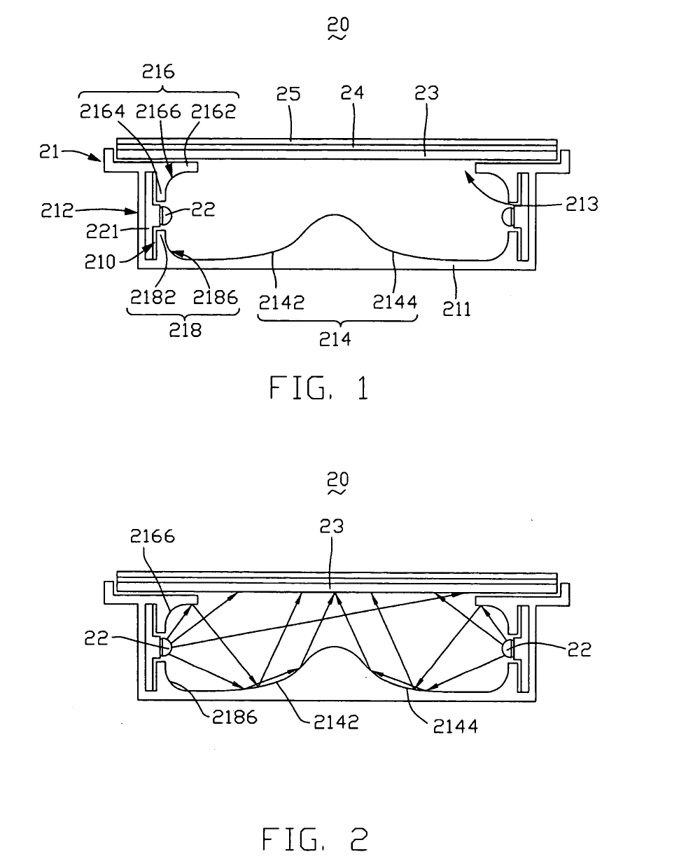

FIG. 2 shows projectile paths of the light rays that are projected into the light diffusion plate 23 by the light sources 22. A projectile path of light rays from the light sources 22 can be reflected by the third reflective surface 2166, the fourth reflective surface 2186, the first curved reflective surfaces 2142 of the protrusion 214, and/or the second curved reflective surfaces 2144 of the protrusion 214, before being finally projected into the light diffusion plate 23. It is to be understood that curved rates of the first through fourth reflective surfaces 2142, 2144, 2166 and 2186 may all be adjusted, so as to attain a good optical performance.

It is noted that the backlight module 20 may further include a prism sheet 24 and a reflective polarizer 25 stacked on the light diffusion plate 23 in that order, for increasing the backlight module 20's optical brightness.

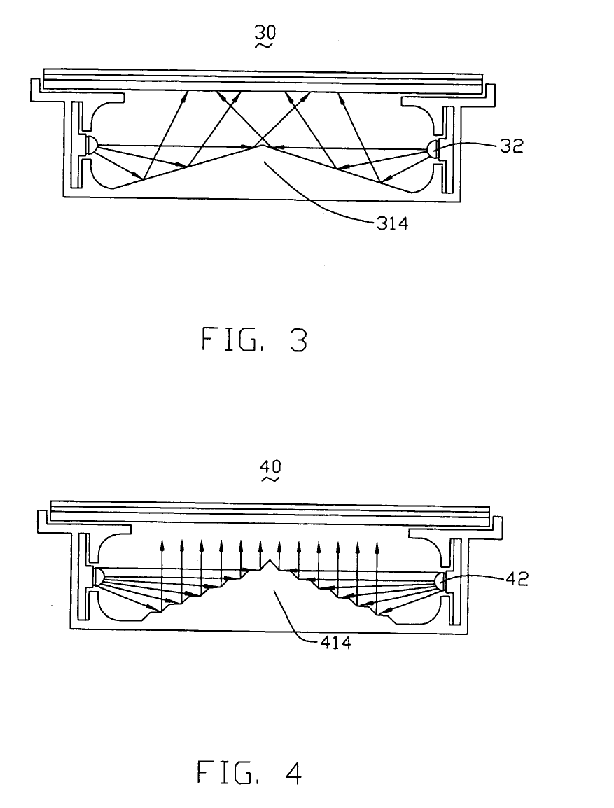

Referring to FIG. 3, a backlight module 30 in accordance with a second preferred embodiment is shown. The backlight module 30 is similar in principle to that of the first embodiment, except that a protrusion 314 has a triangular cross-section taken along a direction perpendicular to two opposing sidewalls 312 that fixes the light sources 32 thereon.

Referring to FIG. 4, a backlight module 40 in accordance with a third preferred embodiment is shown. The backlight module 40 is similar in principle to that of the first embodiment, except that a protrusion 414 has a stepped-shaped cross-section taken along a direction perpendicular to two opposing sidewalls 412 that fixes the light sources 42 thereon.

Referring to FIG. 5, a backlight module 50 in accordance with a fourth preferred embodiment is shown. The backlight module 50 is similar in principle to that of the first embodiment, except that inner surfaces of two opposing sidewalls 512 are slanted inwards in respect to the base 511. An inclination angle (not labeled) defined by the inner surface of the sidewall 512 with respect to the base 511 is configured to be in a range from about 45 degrees to about 90 degrees.

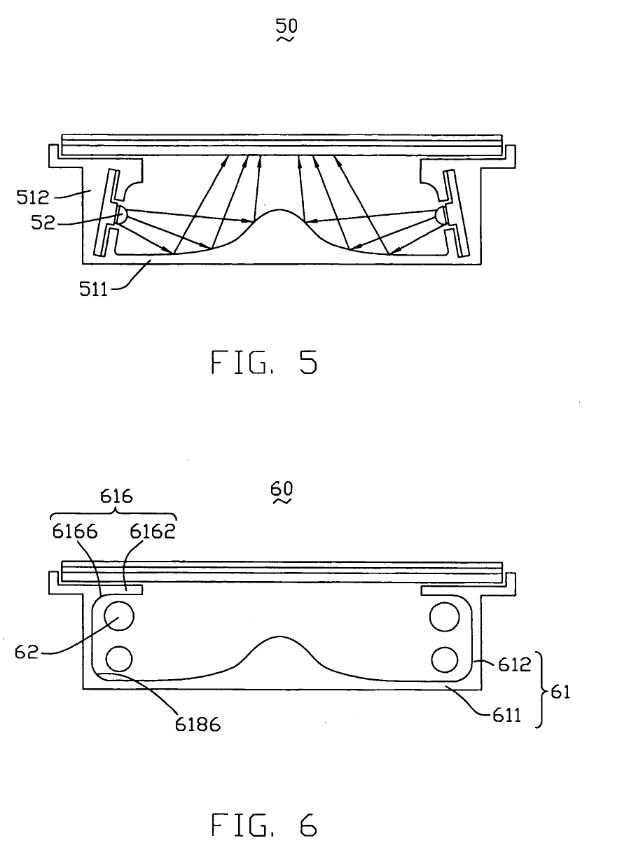

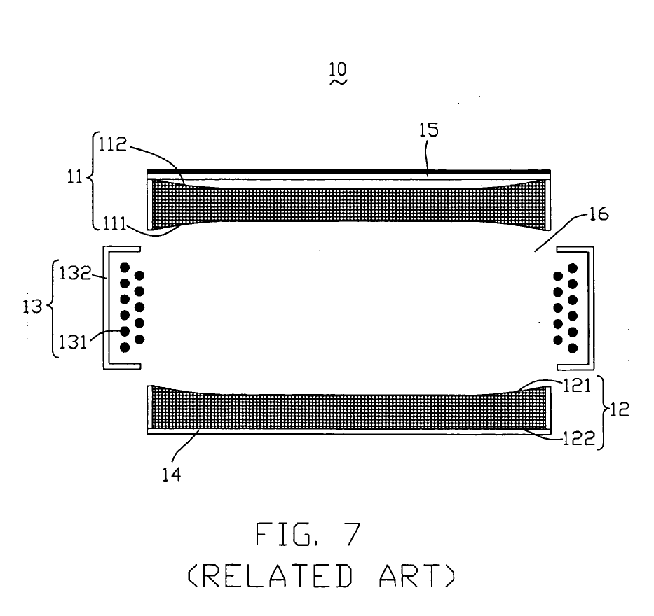

Referring to FIG. 6, a backlight module 60 in accordance with a fifth preferred embodiment is shown. The backlight module 60 is similar in principle to that of the first embodiment, except that light sources 62 employ cold cathode fluorescent lamps (CCFLS). In order to adopt the CCFL light sources 62, a housing 61 of the backlight module 60 further includes two upper reflective units 616 each positioned on a top of the two opposing sidewalls 612. Each upper reflective unit 616 includes a first protruding portion 6162 extending from a top of sidewalls 612 towards an inner area of the housing 61, a third reflective surface 6166 defined by intersection of the first protruding portion 6162 and an inner surface the corresponding sidewall 612. A fourth reflective surface 6186 is defined between the base 611 and an inner surface of the sidewall 612. The light sources 62 are disposed in the housing 61 adjacent and parallel to the two opposing sidewalls 612 respectively.

It is to be understood that the present backlight module may further include a highly reflective film deposited on the two reflective surfaces of the protrusion and the upper and bottom reflective units, for improving the light energy utilization rate. More light sources may be fixed on the other inner surfaces of the sidewalls of the housing to increase optical brightness, and help to increase the optical uniformity when adjusting their suitable positions and quantities. It is to be understood that, the light sources, i.e., LED or CCFLS, may be either fixed to (including in and on) the first sidewall, or adjacent to one of the sidewalls.

The present backlight module have a good optical uniformity by configuring two reflective surfaces of the protrusion to reflect the light rays from the edge light sources to the light diffusion plate. In addition, the present backlight module has a thin body and lightweight by avoided using two light guide plates.

Finally, while the present invention has been described with reference to particular embodiments, the description is illustrative of the invention and is not to be construed as limiting the invention. Therefore, various modifications can be made to the embodiments by those skilled in the art without departing from the true spirit and scope of the invention as defined by the appended claims.

What is claimed is:

1. A backlight module comprising:
a housing having a base, a plurality of sidewalls extending from the peripheral of the base to define an opening, and a protrusion extending out from the base toward the opening, the protrusion having two opposing reflective surfaces facing two opposing sidewalls respectively;
a light diffusion plate disposed on the opening of the housing; and
at least two light sources fixed on inner surfaces of the two opposing sidewalls correspondingly, the two reflecting surfaces uniformly reflecting light from the light sources toward the light diffusion plate.

2. The backlight module according to claim 1, wherein a shape of the protrusion is an elongated ridge extending along a direction parallel to the two opposing sidewalls where the light sources are fixed.

3. The backlight module according to claim 2, wherein the protrusion has a similar semi-circular cross-section taken along a direction perpendicular to the two opposing sidewalls that fixes the light sources thereon, and the two opposing reflective surfaces of the protrusion are curved surfaces connecting with the base.

4. The backlight module according to claim 2, wherein the protrusion has a triangular cross-section taken along a direction perpendicular to two opposing sidewalls that fixes the light sources thereon.

5. The backlight module according to claim 2, wherein protrusion has a stepped-shaped cross-section taken along a direction perpendicular to two opposing sidewalls that fixes the light sources thereon.

6. The backlight module according to claim 1, wherein the housing further comprises two upper reflective units each positioned on a top of the two opposing sidewalls where the light sources are fixed.

7. The backlight module according to claim 6, wherein each upper reflective unit comprises a first protruding portion extending from a top the sidewalls towards an inner area of an upper part of the housing, a second protruding portion extending from a bottom surface of the protruding portion towards the base, and a third reflective surface defined by the intersection between the first protruding portion and the second protruding portion facing the corresponding reflective surface.

8. The backlight module according to claim 6, wherein each upper reflective unit includes a first protruding portion extending from a top of sidewalls towards an inner area of housing, a third reflective surface defined by intersection of the first protruding portion and an inner surface of the corresponding sidewall.

9. The backlight module according to claim 1, wherein the housing further comprises two bottom reflective units each positioned on the base adjacent to the corresponding sidewalls.

10. The backlight module according to claim 9, wherein each bottom reflective unit includes a third protruding portion extending from the base toward the light diffusion plate, and a fourth reflective surface defined by intersection between the base and the third protruding portion, facing the third curved reflective surface and interconnecting the adjacent reflective surface of the protrusion.

11. The backlight module according to claim 9, wherein each bottom reflective unit defines a fourth reflective surface defined by intersection between the base and the corresponding sidewalls and interconnecting the adjacent reflective surface of the protrusion.

12. The backlight module according to claim 1, wherein inner surfaces of two opposing sidewalls that fixes light sources thereon are slanted inwards in respect to the base.

13. The backlight module according to claim 12, wherein an inclination angle defined by the inner surface of the sidewall with respect to the base is configured to be in a range from about 45 degrees to about 90 degrees.

14. The backlight module according to claim 1, wherein the light sources are selected from light emitting diodes and cold cathode fluorescent lamps.

15. The backlight module according to claim 14, wherein the light sources are light emitting diodes, and the light emitting diodes are adhered to the inner surfaces of the two opposing sidewalls.

16. The backlight module according to claim 14, wherein the light sources are light emitting diodes, and the light emitting diodes are aligned apart on an electric circuit board, each electric circuit board with the light emitting diodes is fixed to the inner surface of the two opposing sidewalls.

17. The backlight module according to claim 1, further comprising a prism sheet and a reflective polarizer stacked on the light diffusion plate in that order, for increasing optical brightness.

18. The backlight module according to claim 1, further comprising a highly reflective film deposited on the two reflective surfaces of the protrusion.

19. A backlight module comprising:
a housing including a base and a pair of opposed sidewalls extending from opposite ends the base, the base at a substantially central portion thereof forming a protrusion with a pair of reflective surfaces formed at opposite sides of the protrusion, each of the reflective surfaces substantially rising from a corresponding one of the sidewalls toward the protrusion;
a pair of light sources each fixed to or adjacent a corresponding one of the sidewalls; and
a light diffusion plate placed on the housing with opposite edge portions of the light diffusion plate each aligned with a corresponding one of the sidewalls so that light rays emitted from the light sources are reflected toward the light diffusion plate by the reflective surface.
